(19) United States
(12) Patent Application Publication
(10) Pub. No.: US 2009/0103830 A1
(43) Pub. Date: Apr. 23, 2009

(54) Method of Simulating the Star Cross Effect of a Light Source and Electronic Apparatus Using The Same

(76) Inventor: Chi-Jung Weng, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/252,479

(22) Filed: Oct. 16, 2008

(30) Foreign Application Priority Data
Oct. 17, 2007 (TW) 096138946

(51) Int. Cl. G06K 9/36

(52) U.S. Cl. 382/274

(57) ABSTRACT

A method of simulating the star cross effect of a light source and an electronic apparatus using the method are disclosed. The method comprises the following steps: setting an image processing parameter; obtaining an image information with the electronic apparatus; analyzing the image information to select each usable point light source; and conducting image processing of the star cross effect to each point light source.

### BACKGROUND OF THE INVENTION

1. Field of the Invention

This invention relates to a method of simulating the star cross effect of a light source and an electronic apparatus using the method; more particularly, this invention relates to a method and an apparatus capable of generating a predetermined star cross effect of one or more point light sources so as to capture the image of the point light source with the star cross effect in different scenes.

2. Description of the Related Art

Digital cameras have become must-buy products. Since they are portable and do not require film, digital cameras are often used as recording devices which people bring along with them when engaging in various activities. Basically, digital cameras can be categorized into two groups: consumer-type digital cameras and digital single lens reflex cameras. On most occasions, the former type can meet the users' needs; however, when the users want to capture images of some special scenes or take pictures with special effects, the latter type becomes their only choice. For example, if the users want to take a picture of one or more point light sources (e.g. a street lamp, a candle, or the reflected light of ripples) with the star cross effect, they need a special diaphragm blade and an adjustable diaphragm, both of which are lacking in a consumer-type digital camera. By adjusting the two components and prolonging the shutter exposure time, the users of digital single lens reflex cameras can get the picture they want. To the owner of a consumer-type digital camera, however, the above-mentioned picture is almost unattainable.

This invention is therefore proposed with an aim of finding a way to enhance the functionality of a consumer-type digital camera.

### SUMMARY OF THE INVENTION

It is an object of the present invention to provide a method of simulating the star cross effect of a light source so as to generate the predetermined star cross effect to the point light source in an image.

It is another object of the present invention to provide an electronic apparatus using the method mentioned above.

To attain the aforementioned and other objects of the invention, this invention proposes a method of simulating the star cross effect of a light source applicable to a picture-taking electronic apparatus, the method comprising the following steps: setting an image processing parameter; obtaining an image information with the electronic apparatus; analyzing the image information to select each usable point light source; and conducting image processing of the star cross effect to each point light source. Accordingly, each usable point light source in the image information may, in accordance with the settings of the image processing parameter, demonstrate the star cross effect by the application of image processing.

In addition, the electronic apparatus which uses the aforementioned method may conduct an image process to the image information, and each usable point light source in the image information may be presented with the star cross effect.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is a flowchart of the method of simulating the star cross effect of a light source of this invention.

### DETAILED DESCRIPTION OF THE PREFERRED EMBODIMENT

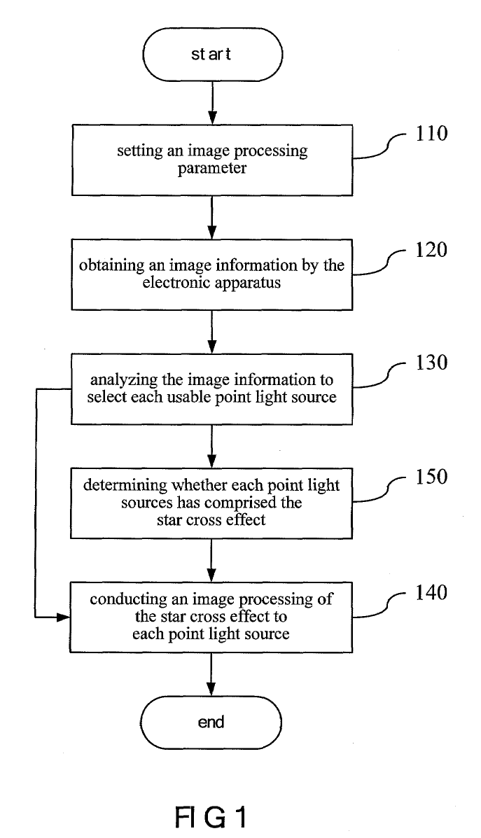

Please refer to FIG. 1 for a flowchart of the method of simulating the star cross effect of a light source of this invention. The method of this invention, which is applicable to a picture-taking electronic apparatus comprising a processing module, comprises the following steps:

Step 110: Setting an Image Processing Parameter.

In this invention, the processing module of the electronic apparatus comprises a software program. An image processing parameter for creating the star cross effect to each point light source in image information may be set via the processing module; the software program may produce a menu interface by which a user may adjust the image processing parameter. In this embodiment, the image processing parameter comprises a light source parameter or a star cross effect parameter. The light source parameter comprises the size limit or brightness limit of each point light source, wherein the size limit represents the area of the point light source, and the brightness limit represent the brightness of the point light source or the contrast between the point light source and its surrounding. The star cross effect parameter comprises a star number, star length, or star width presented by each point light source. In addition, the star number may be generated in a random manner by the processing module, and the star length or star width may be adjusted in accordance with the size or the star number of each point light source. It should be noted that the image processing parameter may be without limitation set automatically in accordance with the default value by the processing module or manually by the user.

Step 120: Obtaining an Image Information by the Electronic Apparatus.

After selecting a scene having one or more point light sources, the user may take pictures with the electronic apparatus so as to obtain an image information which contains one or more point light sources.

Step 130: Analyzing the Image Information to Select Each Usable Point Light Source.

After getting the image information of the scene, the image information may be analyzed with the processing module of the electronic apparatus. The processing module may, in light of the preset light source parameter, determine the usability of each point light source for the follow-up image processing. In this embodiment, the size limit or brightness limit of the point light source may be adopted as the determinant by which the processing module may choose usable each point light source. Unqualified point light sources or noise hot pixels may be excluded accordingly so that the follow-up step may be carried out properly.

Step 140: Conducting an Image Processing of the Star Cross Effect to Each Point Light Source.

After the selection of each usable point light source, the processing module may conduct image processing to each point light source so as to create the star cross effect. The image processing is performed in accordance with the predefined star cross effect parameter. In this embodiment, the processing module is capable of rendering each point light source in the form of identical star cross diffractions in which the star number, star length, or star width is presented as how it is set in advance. However, it should be noted that the star number of each point light source may also be generated randomly, and the star length or star width is adjustable in accordance with the size of each point light source or the star number, enabling each point light sources to be present with different star cross diffraction patterns.

Moreover, between Step 130 and Step 140, the present invention may further comprise Step 150: determining whether each point light sources has comprised the star cross effect. The processing module may analyze whether each point light source has already been conferred with the star cross effect. If the star cross effect is not shown on each point light source, the processing module may conduct the image processing of the star cross effect, either in accordance with the predefined star cross effect parameter or in a random manner; on the contrary, if the star cross effect is presented, the processing module may conduct the image processing on the original star cross effect and adjust the star number, star length, or star width, such as increasing the original star number or extending the original star length.

With the steps mentioned above, the aforementioned electronic apparatus may conduct image processing on any usable point light source when it is used in a scene containing one or more point light sources; therefore, the electronic apparatus meets users' needs with its capability of rendering the star cross effect.

Also, this invention provides an electronic apparatus capable of using the method mentioned above to conduct image processing on image information and create the star cross effect on any usable point light source in the image information. The electronic apparatus may be without limitation a digital camera or other electronic apparatus with a picture-taking function, such as a mobile phone or a personal digital assistant (PDA).

It will be understood that many other modifications can be made to the various disclosed embodiments without departing from the spirit and scope of the invention. For these reasons, the above description should not be construed as limiting the invention, but should be interpreted as merely exemplary of preferred embodiments.

What is claimed is:

1. A method of simulating the star cross effect of a light source, the method being applicable to a picture-taking electronic apparatus comprising a processing module, the method comprising the following steps:
(a) setting an image processing parameter;
(b) obtaining an image information with the electronic apparatus;
(c) analyzing the image information to select each usable point light source; and
(d) conducting image processing of the star cross effect to each point light source.

2. The method as claimed in claim 1, wherein steps (a), (c), and (d) are performed by the processing module, and the processing module comprises a software program.

3. The method as claimed in claim 1, wherein the image processing parameter comprises a light source parameter or a star cross effect parameter.

4. The method as claimed in claim 3, wherein the light source parameter comprises the size limit or brightness limit of the point light source.

5. The method as claimed in claim 4, wherein step (c) analyzes the image information in accordance with the light source parameter to select each usable point light source.

6. The method as claimed in claim 3, wherein the star cross effect parameter comprises a star number, star length, or star width presented by each point light source.

7. The method as claimed in claim 6, wherein step (d) conducts the image processing of the star cross effect to each point light source in accordance with the star cross effect parameter.

8. The method as claimed in claim 6, wherein the star number is generated in a random manner.

9. The method as claimed in claim 6, wherein the star length or the star width is adjustable in accordance with the size or the star number of each point light source.

10. The method as claimed in claim 1, further comprising a step (c1) between step (c) and step (d) which determines whether each point light source has comprised the star cross effect.

11. The method as claimed in claim 10, wherein step (d) adjusts the star number, star length, or star width presented by each point light source which has comprised the star cross effect.
